(19) United States
(12) Patent Application Publication
(10) Pub. No.: US 2026/0186718 A1
(43) Pub. Date: Jul. 2, 2026

(54) STORAGE MEDIUM STORING APPLICATION PROGRAM, CONTROL METHOD, AND INFORMATION PROCESSING APPARATUS

(71) Applicant: CANON KABUSHIKI KAISHA, Tokyo (JP)

(72) Inventor: YOSHIAKI TANI, Ibaraki (JP)

(21) Appl. No.: 19/426,791

(22) Filed: Dec. 19, 2025

(30) Foreign Application Priority Data
Dec. 26, 2024 (JP) 2024-230235

(51) Int. Cl. G06F 3/12

(52) U.S. Cl. CPC G06F 3/1238; G06F 3/1222; G06F 3/1228

(57) ABSTRACT

A non-transitory computer-readable storage medium storing an application program for supporting a standard driver which is provided from a provider of an operating system and has been incorporated in the operating system in advance. The application program causes a computer to execute a display control to display a reception screen to receive authentication information necessary for causing an image processing apparatus having a reading function of reading an original to execute the reading function, and transmission so as to transmit the authentication information received on the reception screen.

### FIELD OF THE TECHNOLOGY

The present technology relates to a storage medium storing an application program, a control method, and an information processing apparatus.

### DESCRIPTION OF THE RELATED ART

To a scanning device (scanner) that performs image reading, i.e. scanning, a host computer (information processing apparatus) that is capable of processing information between the same and the scanning device is communicably connected. As control software for controlling the scanning device, for example, a scan driver installed from the scanning device into the host computer is used. With this scan driver, it is possible to provide a scan instruction from the host computer to the scanning device. In the host computer, an operating system (OS) as basic software is installed in advance. The scan driver is configured according to specifications defined by the OS and can operate when called from the OS. Further, the scan driver is different between vendors that supply scanning devices, i.e. is a model specific driver which is suitable on a scanning device basis.

In recent years, Windows (registered trademark) has a standard class driver (hereinafter sometimes referred to as the “standard driver”) provided therein, which can be commonly used even for scanning devices supplied from a plurality of different vendors, respectively. The standard driver is incorporated in the OS in advance. Then, by connecting a desired scanning device to a host computer having the OS incorporating the standard driver, the standard driver can be used. This makes it possible to omit installation of a model-specific scan driver. Further, the standard driver is assumed to be configured to enable designation of a scan function of the scanning device according to scan function information generated based on information acquired from the scanning device. This makes it possible to designate a scan function for each scanning device by one standard driver.

The standard driver can be commonly used for the scanning devices of a plurality of different vendors, and hence, for example, there is a case where it is impossible to cause a scanning device of a predetermined vendor to execute part of functions of this scanning device. Japanese Laid-Open Patent Publication (Kokai) No. 2021-129155 discloses an information processing apparatus that includes, as a control program used for scan processing, a first program (dedicated scan control program) and a second program (general-purpose scan control program) which is different from the first program. In the information processing apparatus disclosed in Japanese Laid-Open Patent Publication (Kokai) No. 2021-129155, a setting screen for receiving a scan setting used for scan processing is displayed. The setting screen includes, as the scan setting, a first special setting which can be designated for the scan processing using the first program but cannot be designated for the scan processing using the second program. Then, in a case where the first special setting is received on the setting screen, the control program is determined to be the first program, and after that, in a case where the scan setting is changed from the first special setting to a scan setting using the second program, the control program is changed to the second program.

As mentioned above, the scan driver is different for each vendor which supplies a scanning device, i.e. a model specific scan driver suitable on a scanning device basis. Such scan drivers include one having an authentication function of performing, when causing a scanning device to execute the scan function, authentication for determining (presence/absence of) permission of execution of the scan function. With the authentication function, for example, whether or not the scan function of the scanning device can be executed is determined according to a user or a group to which the user belongs. On the other hand, the standard driver does not have the authentication function. Therefore, there is a problem that when causing a scanning device to execute the scan function by the standard driver, it is impossible to perform authentication for determining permission of execution of the scan function.

### SUMMARY

The present disclosure is directed to providing a mechanism that enables an image processing apparatus having a reading function of reading an original to receive authentication information necessary for causing the mage processing apparatus to execute the reading function.

In a first aspect of the present disclosure, there is provided a non-transitory computer-readable storage medium storing an application program causing a computer to execute the following method including supporting a standard driver which is provided from a provider of an operating system, displaying a reception screen for receiving authentication information required to cause an image processing apparatus having a reading function of reading an original to execute the reading function, and receiving the authentication information on the reception screen.

In a second aspect of the present disclosure, there is provided a control method including supporting a standard driver which is provided from a provider of an operating system by executing an application program, displaying a reception screen for receiving authentication information required to cause an image processing apparatus having a reading function of reading an original to execute the reading function by executing the application program, and receiving the authentication information on the reception screen.

Features of the present disclosure will become apparent from the following description of embodiments with reference to the attached drawings. The following description of embodiments is given by way of example.

### BRIEF DESCRIPTION OF THE DRAWINGS

FIG. 1 is a block diagram showing a hardware configuration of a scan system according to a first embodiment.

FIGS. 2A and 2B are block diagrams each showing a software configuration of the scan system.

FIGS. 3A to 3D are diagrams each showing an example of a screen displayed on a display section of the scan system.

FIG. 4 is a flowchart of a process performed by a scan function-extending unit, for editing scan function information.

FIGS. 5A to 5C are diagrams each showing an example of a list of the scan information.

FIG. 6 is a sequence diagram showing a process executed between a scan application, general-purpose scan software, an extension application, and a scanning device, after the scan application receives a scan setting.

FIG. 7 is a flowchart of a process performed by the extension application.

FIG. 8 is a diagram showing an example of a screen displayed on the display section of the scan system in a step of the process in FIG. 7.

FIG. 9 is a sequence diagram showing a process executed, in a second embodiment, between the scan application, the general-purpose scan software, the extension application, and the scanning device, after the scan application receives a scan setting.

FIG. 10 is a flowchart of a process performed by an extension application according to a third embodiment.

FIG. 11 is a diagram showing an example of a screen displayed on the display section of the scan system in a step of the process in FIG. 10.

FIG. 12 is a sequence diagram showing a process executed, in a fourth embodiment, between the scan application, the general-purpose scan software, the extension application, and the scanning device, after the scan application receives a scan setting.

FIG. 13 is a flowchart of a process performed by the extension application.

FIG. 14 is a diagram showing an example of a screen displayed on the display section of the scan system in a step of the process in FIG. 13.

FIGS. 15A and 15B are diagrams each showing an example of a screen displayed on the display section of a scan system according to a fifth embodiment.

FIG. 16 is a sequence diagram showing a process executed between the scan application, the general-purpose scan software, the extension application, and the scanning device, after the scan application receives a scan setting.

FIG. 17 is a block diagram showing a software configuration of a scan system according to a sixth embodiment.

FIG. 18 is a sequence diagram showing a process executed between the scan application, the general-purpose scan software, the extension application, the scanning device, and an authentication server, after the scan application receives a scan setting.

FIG. 19 is a sequence diagram showing a variation of the process executed between the scan application, the general-purpose scan software, the extension application, the scanning device, and the authentication server, after the scan application receives a scan setting.

FIG. 20 is a diagram showing a table used in the third embodiment.

FIG. 21 is a diagram showing a table used in the fourth embodiment.

### DESCRIPTION OF THE EMBODIMENTS

The present disclosure will now be described in detail below with reference to the accompanying drawings showing embodiments thereof. The configuration described in the following embodiments is given only by way of example, and is by no means intended to limit the scope of the present disclosure. For example, components of the present disclosure can be replaced with desired components which can exhibit the same functions. Further, desired components can be added. Further, two or more desired components (features) of the embodiments can be combined.

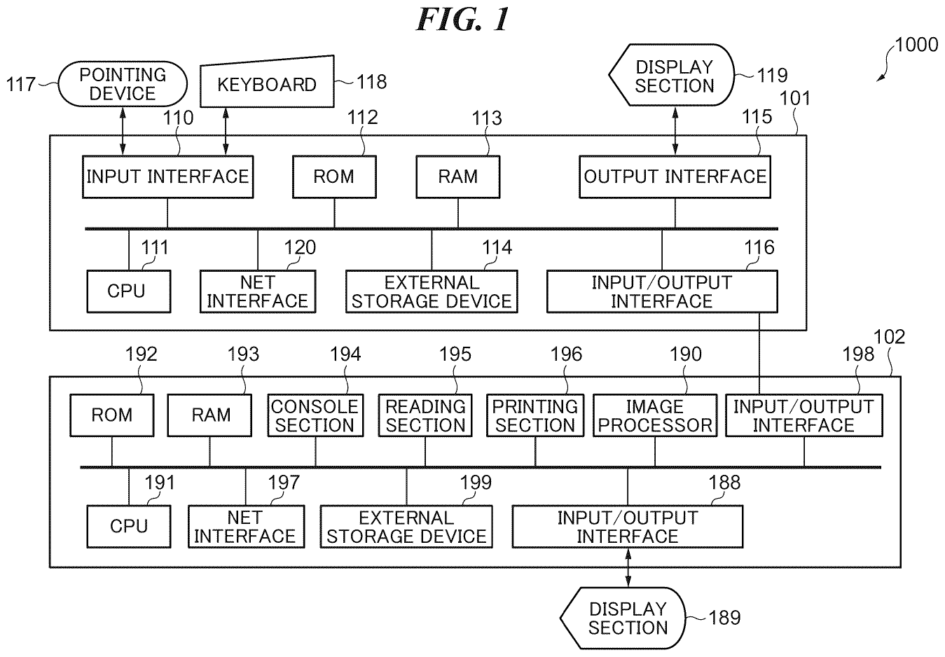

A first embodiment will be described below with reference to FIGS. 1 to 8.

FIG. 1 is a block diagram showing a hardware configuration of a scan system 1000 according to the first embodiment. As shown in FIG. 1, the scan system 1000 includes a host computer 101, a scanning device (scanner) 102, a pointing device 117, a keyboard 118, and a display section 119, and these are communicably connected to each other. The host computer 101 is an information processing apparatus and includes an input interface 110, a central processing unit (CPU) 111, a read only memory (ROM) 112, a random access memory (RAM) 113, an external storage device (storage medium) 114, an output interface 115, an input/output interface 116, and a network (NET) interface 120. Note that although as the host computer 101, for example, a desktop-type personal computer can be used, this is not limitative, but for example, a laptop-type personal computer, a tablet terminal, or a smartphone can be used.

The CPU 111 is a computer that executes e.g. programs stored in the ROM 112 and the external storage device 114. Note that in the present embodiment, the CPU 111 is capable of executing functions and processing of the host computer 101, i.e. steps (control method) and the like, described hereinafter, by performing processing according to a program code stored in the ROM 112. In the ROM 112, an initialization program is stored. In the external storage device 114, an application program group, an operating system (OS), print data generation software, and a variety of other data are stored. Note that in the present embodiment, as the OS, Windows (registered trademark) 11 of Microsoft (registered trademark) is installed in the host computer 101. The external storage device 114 is not particularly limited, but for example, a hard disk drive (HDD) or a solid state drive (SSD) can be used. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a scan setting screen 300A and a detailed setting screen 300C, described hereinafter, are displayed. The NET interface 120 is a network interface and performs control to transfer data to and from an external apparatus via a network. To the input/output interface 116, the scanning device 102 is connected. This enables the host computer 101 to communicate with the scanning devices 102 of a plurality of makers, i.e. process information between the host computer 101 and the scanning devices 102 of the plurality of makers regardless of the maker of the scanning device 102. The host computer 101 and the scanning device 102 can be wired connected or wirelessly connected.

The scanning device 102 is an image processing device including an image processor 190, a CPU 191, a ROM 192, a RAM 193, a console section 194, a reading section 195, a printing section 196, a NET interface 197, an input/output interface 198, and an external storage device 199. The CPU 191 is a computer that executes e.g. programs stored in the ROM 192 and the external storage device 199 and performs centralized control of the scanning device 102. The ROM 192 is a memory for storing the programs. The RAM 193 is a memory for temporarily storing a program and image data. On the console section 194, a variety of operation instructions can be provided to the scanning device 102. Note that the console section 194 is configured to be capable of displaying a variety of information items, such as a state of the scanning device 102. The reading section 195 reads an image from an original. The printing section 196 prints an image on a sheet based on image data generated e.g. by reading an image from an original in the reading section 195. Note that the printing section 196 can be omitted. The NET interface 197 is a network interface and performs control to transfer data to and from an external apparatus via a network. To the output interface 198, a display section 189 is connected. To the input/output interface 198, the host computer 101 is connected. To the image processor 190, for example, image data generated by reading an image from an original in the reading section 195 is input. Then, the image processor 190 performs various types of edit processing operations on the image data.

The scanning device 102 is not particularly limited insofar as it is an apparatus having an image reading function, i.e. a scan function, but for example, an image processing apparatus, such as a multi-function peripheral (MFP), can be used. Further, the scanning device 102 has an original platen glass (not shown) and a feeder (not shown). The original platen glass is a first placement section on which one original as an execution target of the reading function is placed. The feeder is a second placement section which is arranged at a location different from the original platen glass and on which a plurality of original sheets as an execution target of the reading function are placed. Further, in a case where the MFP is used as the scanning device 102, printing performed by the MFP is printing using the electrophotographic method in the present embodiment but is not limited to this, and, for example, printing using the inkjet method can be performed. Further, although in the present embodiment, the host computer 101 and the scanning device 102 are configured as separate apparatuses different from each other, this is not limitative. For example, the host computer 101 and the scanning device 102 can be configured as an integrated apparatus.

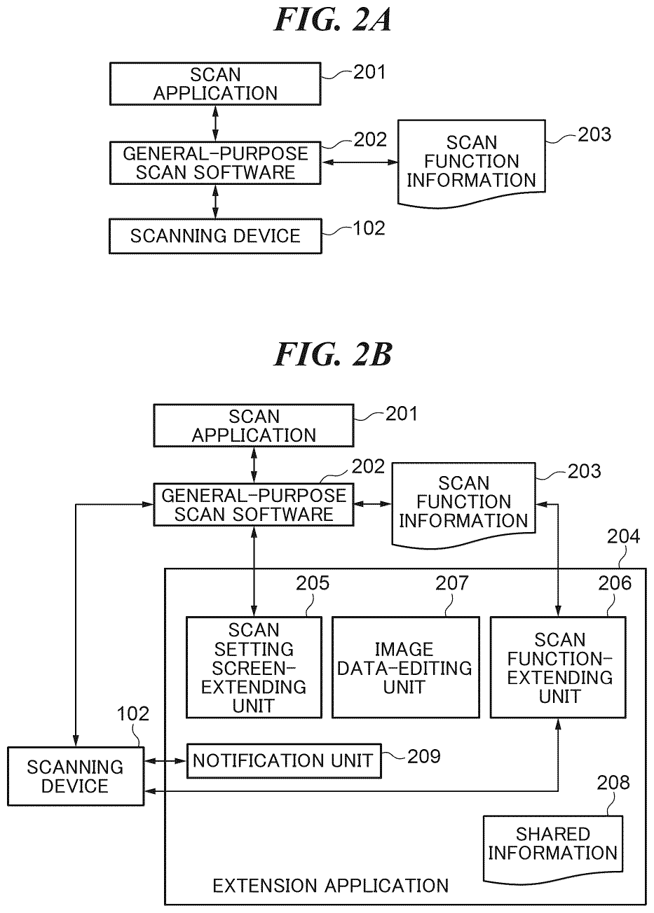

FIGS. 2A and 2B are block diagrams each showing a software configuration of the scan system 1000. FIG. 2A is a diagram showing a general configuration in a case where an extension application (application program) 204 is not associated with general-purpose scan software (standard driver) 202 and the scanning device 102. FIG. 2B is a diagram showing a configuration in a case where the extension application 204 is associated with the general-purpose scan software 202 and the scanning device 102. The general-purpose scan software 202 is a standard driver that is provided from a provider of the OS and incorporated in the OS in advance. The standard driver is a class driver (general-purpose program) which can be commonly used for the scanning devices 102 of a plurality of makers, for example, when scanning (image reading) is performed. The standard driver is provided as one of functions in the OS package with the OS. The standard driver can perform processing for a variety of scanning devices by using a standardized scanning method. With this, the standard driver can generate and output an instruction which can be interpreted by the scanning devices 102 of the plurality of makers. Note that the standard driver is not particularly limited, but for example, a program which operates based on the Internet Printing Protocol (IPP) is used. This general-purpose scan software 202 is installed (incorporated) in the OS in advance.

The extension application 204 is a program supporting, i.e. assisting the general-purpose scan software 202 (program that executes a control method of performing control to support the general-purpose scan software 202). In the present embodiment, the extension application 204 is an extension program which can extend functions which cannot be executed by the general-purpose scan software 202 for the scanning device 102, but is not limited to this. For example, the extension application 204 can be a program which improves the convenience of functions which can be executed by the general-purpose scan software 202 for the scanning device 102. The extension application 204 is stored e.g. in the external storage device 114 together with the OS (the general-purpose scan software 202). With this, the host computer 101 has the general-purpose scan software 202 and the extension application 204.

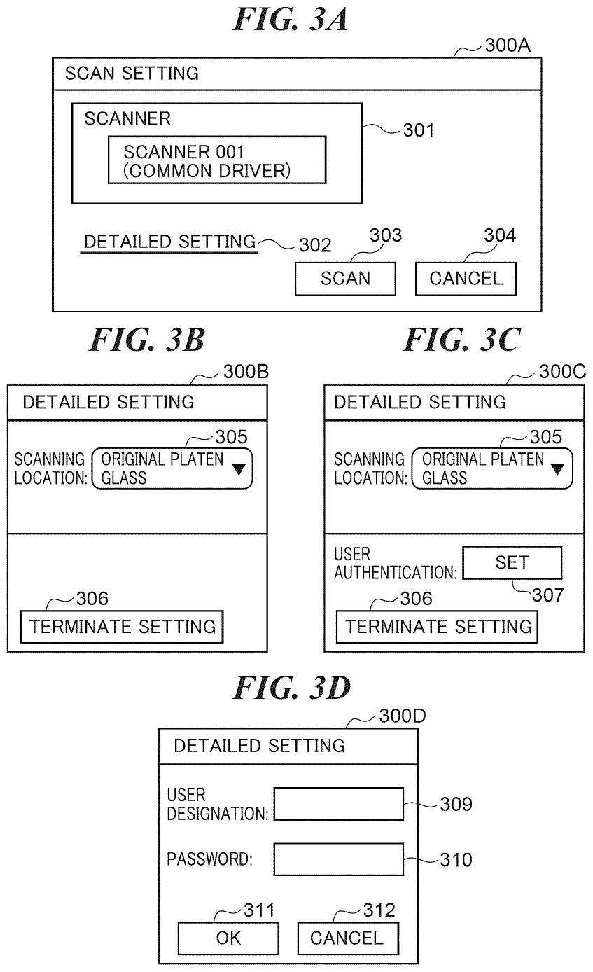

First, referring to FIG. 2A, the configuration in the case where the extension application 204 is not associated with general-purpose scan software 202 and the scanning device 102 will be described. A scan application 201 is software for taking in contents (image data) generated by scanning performed by the scanning device 102. The scan application 201 is not particularly limited, but can be, for example, a document generation application and an image editing application. The scan application 201 issues a scan instruction to the OS e.g. upon receipt of a scan request from a user. The scan instruction includes scan setting information for instructing operations of the general-purpose scan software 202 and the scanning device 102. To issue a scan instruction, the scan application 201 can display the scan setting screen 300A provided by one of the general-purpose scan software 202, the OS, and the scan application 201, on the display section 119. Further, by operating a control 302 (see FIG. 3A) in the scan setting screen 300A, the scan application 201 can display, for example, a detailed setting screen 300B (see FIG. 3B) on the display section 119. The scan setting screen 300A and the detailed setting screen 300B, and further, the detailed setting screen 300C and a detailed setting screen 300D will be described hereinafter. The scan setting screen 300A includes a setting item indicating a scan function which can be set according to capabilities information acquired by the general-purpose scan software 202, i.e. information which can be set as the scan setting, and a control item indicating a setting of the setting item. The “capabilities information” refers to information related to the capabilities of the scanning device 102 for performing scan and the like. Further, with this capabilities information, it is also possible to determine whether or not information indicating capability of the display of the detailed setting screen 300C is included. Then, as a result of this determination, if it is determined that the information indicating capability of display of the detailed setting screen 300C is included, the detailed setting screen 300C can be displayed. On the other hand, if it is determined that the information indicating capability of the display of the detailed setting screen 300C is not included, the display of the detailed setting screen 300C is inhibited. Thus, the extension application 204 can switch whether or not to display the detailed setting screen 300C according to the capabilities information of the scanning device 102.

Scan function information 203 is data indicating scan functions, which describes all scan functions which can be set, settings of these scan functions, an exclusive relation between settings, and so forth. The scan function information 203 is included in a configuration file of the general-purpose scan software 202 and is disposed in the external storage device 114 as an unchangeable file. Alternatively, the scan function information 203 is dynamically generated by the general-purpose scan software 202. Specifically, the general-purpose scan software 202 acquires attribute data of the scanning device 102 from the scanning device 102. The general-purpose scan software 202 generates the scan function information 203 according to attribute information in the attribute data. Note that in a case where the scan function information 203 is dynamically generated as described above, the scan information 203 can be edited. Further, the attribute data of the scanning device 102 includes the attribute information indicating the functions which can be designated in the scanning device 102 (capabilities of the scanning device 102) and settings associated with the attribute information, and these are stored in the RAM 113.

With this configuration, the general-purpose scan software 202 enables a user to designate a scan function which can be used in the scanning device 102 according to the scanning device 102 connected to the host computer 101. With this, regardless of the scanning device 102, i.e. even in a case where the scanning device 102 having different functions or the scanning device 102 developed by a different scanner maker is connected, it is possible to designate a scan function which can be used in the connected scanning device 102. Note that in the present embodiment, the general-purpose scan software 202 is a standard class driver that executes scanning based on a standard scan protocol called Mopria (registered trademark). Specifically, as described above, the general-purpose scan software 202 is not a scan driver specific to a model of the scanning device 102 but is a standard class driver which can be commonly used for scanning devices 102 of scanner makers, without depending on a specific scanner maker. Further, the general-purpose scan software 202 acquires the capabilities information of the scanning device 102 and generates the scan function information 203 based on the acquired information.

Further, the general-purpose scan software 202 can be associated with the extension application 204. This enables the general-purpose scan software 202 to execute a function which is not supported by the general-purpose scan software 202. For example, the general-purpose scan software 202 cannot cause the scanning device 102 to perform, when causing the scanning device 102 to execute the scan function, authentication necessary for execution of the scan function, i.e. determination of whether or not to permit execution of the scan function. Thus, the general-purpose scan software 202 does not support the authentication processing setting for causing the scanning device 102 to execute authentication processing. This is because this authentication processing setting is a function uniquely executed by the scanning device 102 manufactured by a predetermined scanner maker. The extension application 204 can extend functions of the general-purpose scan software 202 such that functions which cannot be executed by the general-purpose scan software 202 can be executed. Although in the present embodiment, the general-purpose scan software 202 cannot perform the authentication processing setting, and the extension application 204 can extend the function such that the authentication processing setting can be executed, this is not limitative. For example, in a case where the general-purpose scan software 202 can execute part of the authentication processing setting, the extension application 204 can further extend the execution range by compensating for the shortage of the authentication processing setting.

The configuration in the case where the extension application 204 is associated with the general-purpose scan software 202 and the scanning device 102 will be described with reference to FIG. 2B. As shown in FIG. 2B, differently from FIG. 2A, the extension application 204 is added. That is, the host computer 101 includes the scan application 201, the general-purpose scan software 202, and the scan function information 203, and further has the extension application 204. The extension application 204 is software for extending the function of the general-purpose scan software 202 and is sometimes simply referred to as the “scan software”. Note that the extension application 204 is software which is not included (packaged) in the OS in advance. Therefore, the extension application 204 is downloaded from a server (not shown) via the Internet and installed into the host computer 101 according to a user's operation of the host computer 101. Alternatively, when the scanning device 102 is connected to the host computer 101, the extension application 204 can be automatically installed into the host computer 101 according to this connection. Specifically, in a case where the scanning device 102 is connected to the host computer 101, the OS acquires device identification information from the scanning device 102. The OS can download the extension application 204 associated with this device identification information from the server via the Internet and install the downloaded extension application 204. As a result, in the host computer 101, the general-purpose scan software 202 and the extension application 204 are held as control programs independent of each other. Note that the general-purpose scan software 202 and the extension application 204 are sometimes updated and their versions are upgraded, respectively. The processing for updating the general-purpose scan software 202 and the processing for updating the extension application 204 in this case are performed at the same timing or at different timings. Further, a trigger with which the general-purpose scan software 202 is acquired by the host computer 101 and a trigger with which the extension application 204 is acquired by the host computer 101 are the same trigger or different triggers. Further, in a case where the extension application 204 has been installed, the OS associates the extension application 204 with the general-purpose scan software 202 and the scanning device 102.

As shown in FIG. 2B, the extension application 204 is capable of exchanging information with (transmitting and receiving information to and from) the general-purpose scan software 202 and the scanning device 102, respectively. That is, the extension application 204 is associated with the general-purpose scan software 202 and the scanning device 102. In the present embodiment, the extension application 204 includes a scan setting screen-extending unit 205, a scan function-extending unit 206, an image data-editing unit 207, and a notification unit 209. Further, the extension application 204 includes shared information 208 which can be accessed from each of the scan setting screen-extending unit 205, the scan function-extending unit 206, the image data-editing unit 207, and the notification unit 209. The shared information 208 is a file stored in the external storage device 114 or information stored in the RAM 113. The extension application 204 can write and read the shared information 208 by using an application program interface (API) provided by the OS.

Note that the extension application 204 can terminate the entire operation of the extension application 204 in accordance with termination of processing executed by each of the scan setting screen-extending unit 205 to the notification unit 209. In this case, the OS starts the extension application 204 whenever a request for causing each unit to execute processing is received. Further, while the processing is being performed by each of the scan setting screen-extending unit 205 to the notification unit 209, the extension application 204 can cancel this processing. In this case, a job being processed on a print queue is deleted by the OS. As described above, upon receipt of a print request from a user, the scan application 201 issues a scan instruction to the OS. Further, the scan application 201 can display the scan setting screen. In the configuration shown in FIG. 2B, the scan application 201 can display the scan setting screen 300A (detailed setting screen 300C) provided by the scan setting screen-extending unit 205 (the extension application 204). Further, the scan setting screen-extending unit 205 can store detailed settings made by the user in the shared information 208.

The image data-editing unit 207 acquires image data from the scanning device 102. Then, after acquisition of the image data, the image data-editing unit 207 can also edit the acquired image data. Further, the image data-editing unit 207 acquires detailed setting information from the shared information 208 and performs image editing on the image data according to the detailed setting information. The extension application 204 can perform image editing on image data acquired by the general-purpose scan software 202 according to the detailed setting information.

The scan function-extending unit 206 can edit the scan function information 203 generated by the general-purpose scan software 202 or the OS. This makes it possible to add a function provided by the extension application 204. Further, it is also possible to add a function which can be executed in the scanning device 102 but cannot be executed by the general-purpose scan software 202 (such as the authentication processing-setting function) and add an exclusive relationship between settings of the scan function and the like. The OS starts the scan function-extending unit 206 when the extension application 204 is associated with the scanning device 102 and the general-purpose scan software 202 for the first time. Further, the OS can start the scan function-extending unit 206 at a timing other than this (such as a timing when the OS is started). By starting the scan function-extending unit 206 as described above, the scan function-extending unit 206 can detect the extended function and add the detected function to the scan function information 203, even in a case where a function related to scanning is extended later.

The notification unit 209 can provide, when an error of the scanning device 102 occurs, a notification indicating this fact. For example, if a reading jam error has occurred in the scanning device 102, the general-purpose scan software 202 detects occurrence of this error. The OS displays a message showing occurrence of the reading jam error as a result of the detection performed by the general-purpose scan software 202 on the display section 119 by using a notification function referred to as the toast notification which is one of the functions of the OS. Note that when the user operates the toast notification, the notification unit 209 is called by the OS, and a user interface screen (UI screen) of the notification unit 209 is displayed. On the user interface screen, there can be displayed, for example, a detailed message concerning the reading jam error, a jam resolving method, and so forth.

As described above, in the present embodiment, it can be said that the extension application 204 has the following four functions: The first function is the function of displaying a setting screen. This function is executed by the scan setting screen-extending unit 205. The second function is the function of editing image data according to the detailed setting information. This function is executed by the image data-editing unit 207. The third function is the function of extending a function which can be designated by using image data generation software. This function is executed by the scan function-extending unit 206. The fourth function is the function of displaying a screen in response to occurrence of an error in the scanning device 102. This function is executed by the notification unit 209. Note that the configuration of the extension application 204 is not limited to the configuration having these four functions, but the extension application 204 is preferably configured to have at least one function of them, and further, the extension application 204 can be configured to further have another function.

FIGS. 3A to 3D are diagrams each showing an example of a screen displayed on the display section 119 of the scan system 1000. FIG. 3A shows the scan setting screen displayed by the scan application 201. FIG. 3B shows the detailed setting screen displayed in the case of the configuration in which the extension application 204 is not associated. FIG. 3C shows the detailed setting screen displayed in the case of the configuration in which the extension application 204 is associated. FIG. 3D shows the detailed setting screen shifted from the detailed setting screen shown in FIG. 3C. Note that a unit or module that displays each screen is not particularly limited. For example, the scan setting screen-extending unit 205 can be configured to only generate a display screen. In this case, the scan setting screen-extending unit 205 transmits the generated display screen to the scan application 201 via the general-purpose scan software 202. The scan application 201 can be configured to display the acquired display screen.

The scan setting screen 300A shown in FIG. 3A is a screen on which a setting related to scanning performed by the scanning device 102 can be made. This scan setting screen 300A includes a control (button) 301, a control 302, a control 303, and a control 304. With the control 301, the user can select and set a scanner device used for reading an original. In the illustrated example in FIG. 3A, the scanner device used for reading an original is set to “scanner 001 (common driver)” by way of example. With the control 302, the user can cause a screen to be displayed on which detailed settings related to scanning can be made. With the control 303, the user can instruct the scanning device 102 to start scanning. With the control 304, the user can instruct the scanning device 102 to cancel scanning.

By operating the control 302 in a case where the extension application 204 is configured to be not associated therewith, the detailed setting screen 300B shown in FIG. 3B is displayed. The detailed setting screen 300B includes a control 305 and a control 306. The control 305 is a placement selection section on which the user can select and set a placement section where an original to be read is placed. As described above, the scanning device 102 has the original platen glass and the feeder, as the original scanning locations. In this case, on the control 305 in FIG. 3B, “original platen glass” is selected by way of example. With the control 306, the user can terminate setting on the control 305. Further, by operating the control 306, the screen returns to the scan setting screen 300A shown in FIG. 3A.

By operating the control 302 in a case where the extension application 204 is configured to be associated therewith, the detailed setting screen (reception screen) 300C shown in FIG. 3C is displayed (display control step). Note that the detailed setting screen 300C is a screen displayed together with the scan setting screen 300A, but its display form is not particularly limited. For example, the detailed setting screen 300C can be displayed in a state overlapping the scan setting screen 300A. Further, the detailed setting screen 300C can be displayed adjacent to the scan setting screen 300A or can be displayed after the scan setting screen 300A once disappears. Similar to the detailed setting screen 300B, the detailed setting screen 300C includes the control 305 and the control 306. Further, the detailed setting screen 300C additionally includes a control 307. The control 307 is an operation section for receiving authentication information necessary for causing the scanning device 102 to execute the reading function.

By operating the control 307, the authentication processing setting is validated, and the detailed setting screen (reception screen) 300D shown in FIG. 3D is displayed. Note that the display form of the detailed setting screen 300D is not particularly limited. For example, the detailed setting screen 300D can be displayed in a state overlapping the detailed setting screen 300C. Further, the detailed setting screen 300D can be displayed adjacent to the detailed setting screen 300C or can be displayed after the detailed setting screen 300C once disappears. The detailed setting screen 300D is an input screen for inputting authentication information. This detailed setting screen 300D includes a control 309 to a control 312. The control 309 is a user designation input section for inputting a designation of a user who asks permission to execute the reading function of the scanning device 102, as the authentication information. The user designation is not particularly limited, but, for example, the name of a user, an employee number of the user, an identifier (ID) of the user, or the name of a department to which the user belongs can be used. The control 310 is a password input section for inputting a password of a user having the designation input on the control 309, as the authentication information. The password is not particularly limited, but for example, a password set by a user or a PIN code can be used. The input operations to the control 309 and the control 310 are performed e.g. by using the keyboard 118. Note that the detailed setting screen 300C can include the control 309 and the control 310 in place of the control 307. In this case, the detailed setting screen 300D is omitted. With the control 311, the user can store the input state to the control 309 and the control 310 and terminate the detailed setting screen 300D. With the control 312, the user can cancel the input state to the control 309 and the control 310 and terminate the detailed setting screen 300D. Then, after termination of the detailed setting screen 300D, the screen returns to the detailed setting screen 300C. Note that after termination of the detailed setting screen 300D, the screen can return to the scan setting screen 300A shown in FIG. 3A. Further, on the host computer 101, the detailed setting screen 300D can be displayed after the control 302 on the scan setting screen 300A is operated or can be displayed after the control 303 is operated. In this case, the control 307 is omitted from the detailed setting screen 300C.

Here, a reason why the items included in the detailed setting screen 300B shown in FIG. 3B and the items included in the detailed setting screen 300C shown in FIG. 3C are different will be described. That is, a reason why it is possible to switch whether to display the detailed setting screen 300B or to display the detailed setting screen 300C will be described. The detailed setting screen 300B and the detailed setting screen 300C are generated based on respective pieces of the scan function information (capabilities information). As described above, the general-purpose scan software 202 does not support the authentication processing setting. Therefore, the authentication processing setting function cannot be added to the scan function information only by the general-purpose scan software 202. Further, even if the authentication processing setting function is originally included in the scan function information, the general-purpose scan software 202 cannot interpret the authentication processing setting function included in the scan function information. For this reason, the authentication processing setting cannot be displayed on the detailed setting screen. To cope with this, the scan function-extending unit 206 adds the authentication processing setting function to the scan function information 203. Then, the scan setting screen-extending unit 205 displays the detailed setting screen 300C by referring to the capabilities information. This detailed setting screen 300C is a screen on which the authentication processing setting can be made. Note that the detailed setting screen 300C can additionally include a setting item (control 307) other than the authentication processing setting.

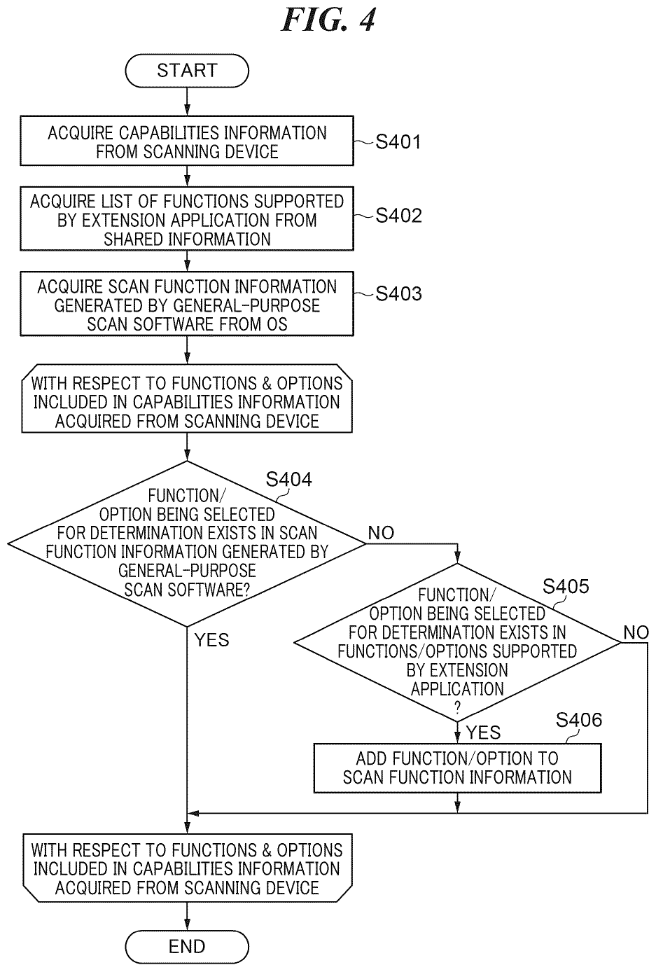

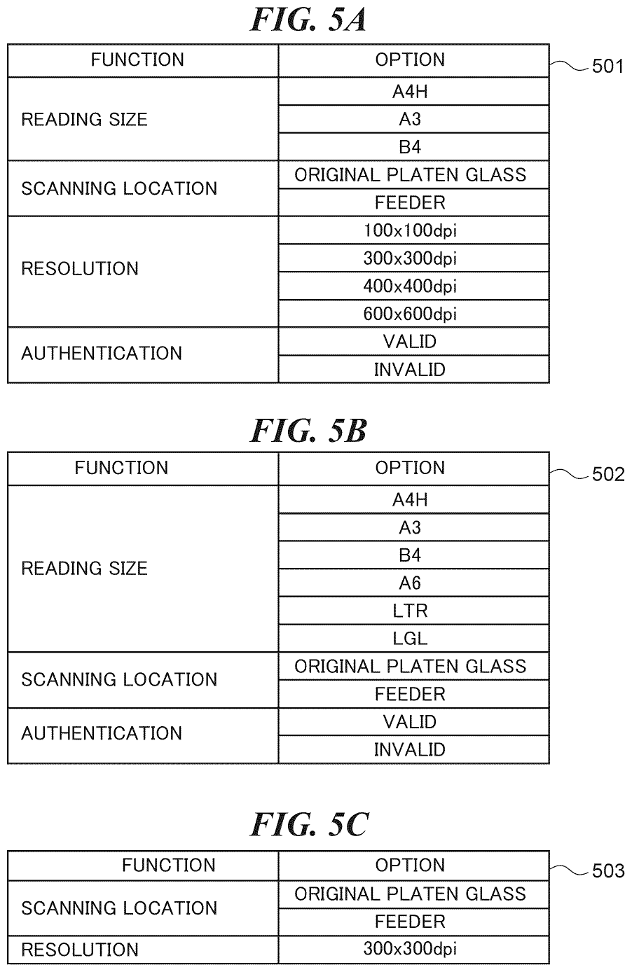

FIG. 4 is a flowchart of a process performed by the scan function-extending unit 206, for editing the scan function information. Note that a program for executing the process in FIG. 4 is executed by the scan function-extending unit 206 under the control of the CPU 111. FIGS. 5A to 5C are diagrams each showing an example of a list of the scan information. As shown in FIG. 4, in a step S401, the scan function-extending unit 206 acquires the capabilities information from the scanning device 102. The capabilities information is information concerning the capabilities to execute the scan function, and in the present embodiment, includes attribute information indicating the functions which can be designated for the scanning device 102 and settings associated with this attribute information. A table 501 shown in FIG. 5A indicates a list of the capabilities information acquired from the scanning device 102. As shown in the table 501, the functions, such as the authentication processing, and options which can be set to each function, can be acquired from the scanning device 102. For example, the authentication processing function has, as its options, “valid” indicating that the authentication processing function is validated and “invalid” indicating that the authentication processing function is invalidated.

In a step S402, the scan function-extending unit 206 acquires scan functions supported by the extension application 204 from the shared information 208. In the shared information 208, a list of the scan functions supported by the extension application 204 is stored. A table 502 shown in FIG. 5B includes all scan functions which can be executed (supported) by the extension application 204 and the settings of these scan functions. For example, the authentication processing function has, as its options, “valid” indicating that the authentication processing function is validated and “invalid” indicating that the authentication processing function is invalidated. Further, the scan functions which can be executed by the extension application 204 are sometimes updated e.g. by the update of the extension application 204.

In a step S403, the scan function-extending unit 206 acquires the scan function information 203 generated by the general-purpose scan software 202 from the OS. The scan function information 203 is generated by the general-purpose scan software 202 based on the capabilities information acquired from the scanning device 102. The scan function information 203 generated by the general-purpose scan software 202 includes only the scan functions which can be executed by the general-purpose scan software 202, out of the capabilities information acquired from the scanning device 102. A table 503 shown in FIG. 5C includes all scan functions which can be executed by the general-purpose scan software 202 and the settings of these scan functions. As shown in the table 503, the scan functions which can be executed by the general-purpose scan software 202 do not include the authentication processing function. Therefore, the authentication processing setting is not included in the scan function information 203. By adding a function and options thereof to the scan function information 203 by using the scan function-extending unit 206, the extension application 204 can compensate for shortage of the functions of the general-purpose scan software 202. Further, the scan function-extending unit 206 is also capable of deleting an unnecessary function and options thereof from the scan function information 203 generated by the general-purpose scan software 202.

A step S404, a step S405, and a step S406 are processing operations which are repeatedly executed on the list of the functions included in the capabilities information acquired from the scanning device 102 in the step S401. In the present embodiment, the steps S404, S405, and S406 are repeatedly executed on all of the 11 options included in the table 501.

In the step S404, the scan function-extending unit 206 determines whether or not a function and its option, being currently selected for determination, exist in the scan function information 203 generated by the general-purpose scan software 202. If it is determined in the step S404 that the function and its option, being currently selected for determination, exist in the scan function information 203, the present process is terminated provided that the option being selected for determination is the final item of the options of the function. Alternatively, if the option being selected for determination is not the final item of the options of the function, the next item of the options is selected, and the step S404 is executed again. On the other hand, if it is determined in the step S404 that the function and its option, being currently selected for determination, do not exist in the scan function information 203, the process proceeds to the step S405. For example, in the present embodiment, the scanning location of “original platen glass” is included in the table 501, and the scanning location of “original platen glass” is also included in the table 503. In this case, it is determined in the step S404 that the function and its option, being currently selected for determination, exist in the scan function information 203. On the other hand, “valid” of the authentication processing setting is included in the table 501 but “valid” of the authentication processing setting is not included in the table 503. In this case, it is determined in the step S404 that the function and its option, being currently selected for determination, do not exist in the scan function information 203.

In the step S405, the scan function-extending unit 206 determines whether or not the function and its option, being currently selected for determination, exist in the functions and their options supported by the extension application 204. If it is determined in the step S405 that the function and its option, being currently selected for determination exist, the process proceeds to the step S406. On the other hand, if it is determined in the step S405 that the function and its option being currently selected for determination do not exist, similar to the case where the answer to the question of the step S404 is affirmative (YES), the present process is terminated provided that the option being selected for determination is the final item of the options of the function. Alternatively, if the option being selected for determination is not the final item of the options of the function, the next item of the options is selected, and the step S404 is executed again. For example, in the present embodiment, in a case where the authentication processing setting as the function being currently selected for determination is “valid”, the option “valid” also exists in the table 502. Therefore, it is determined in the step S405 that the function being currently selected for determination exists.

In the step S406, the scan function-extending unit 206 adds the function and its option being currently selected for determination to the scan function information 203. After execution of the step S406, similar to the case where the answer to the question of the step S404 is affirmative (YES), the present process is terminated provided that the option being selected for determination is the final item of the options of the function. Alternatively, if the option being selected for determination is not the final item of the options of the function, the next item of the options is selected, and the step S404 is executed again.

As described above, the extension application 204 can add, to the scan function information 203, a function and its option which are not supported by the general-purpose scan software 202 but are supported by the scanning device 102, and at the same time can be supported by the extension application 204. Then, the capabilities information is generated based on the scan function information 203 edited by this addition processing. Further, by generating a display screen based on the resulting capabilities information, the scan setting screen-extending unit 205 can extend the function not supported by the general-purpose scan software 202 and display the detailed setting screen 300C and the detailed setting screen 300D.

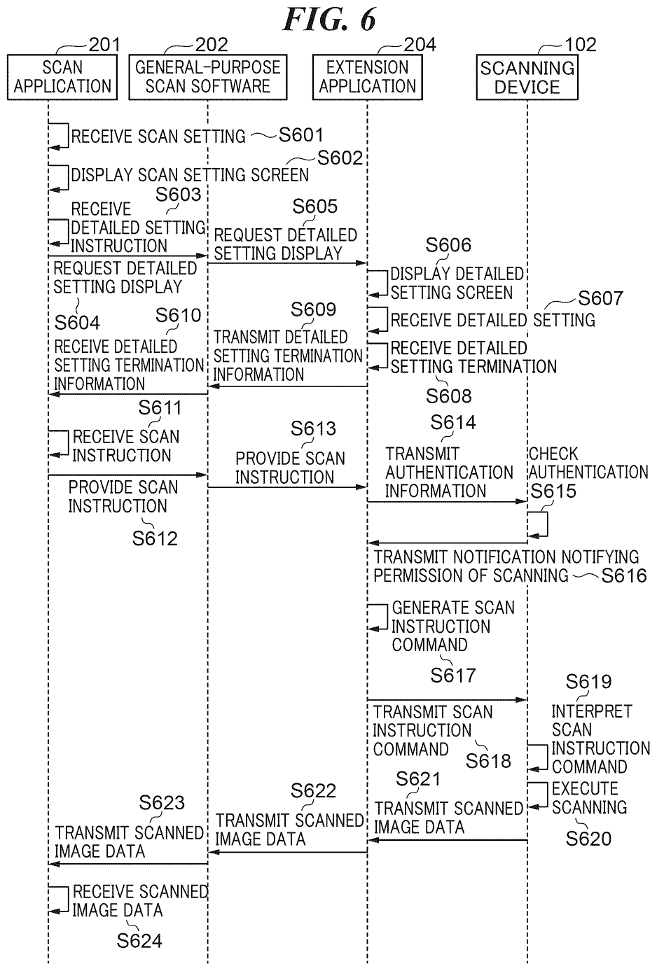

FIG. 6 is a sequence diagram showing a process executed between the scan application 201, the general-purpose scan software 202, the extension application 204, and the scanning device 102, after the scan application 201 receives a scan setting. Processing operations performed by the scan application 201, the general-purpose scan software 202, and the extension application 204 are executed by the CPU 111 of the host computer 101. This processing program is stored in the external storage device 114. Then, the CPU 111 loads the processing program from the external storage device 114 into the RAM 113 and executes the loaded processing program. Further, processing operations performed by the scanning device 102 are executed by the CPU 191 of the scanning device 102. This processing program is stored in the external storage device 199. The CPU 191 loads the processing program from the external storage device 199 into the RAM 193 and executes the loaded processing program. Note that the processing operations in the scanning device 102 can be executed by the CPU 111 via the CPU 191. Further, the software configuration of the scan system 1000 is the software configuration shown in FIG. 2B.

Referring to FIG. 6, in a step S601, the scan application 201 receives the scan setting by a user. The user can instruct the scan setting to the scan application 201 by operating e.g. the pointing device 117 and the keyboard 118.

In a step S602, the scan application 201 displays the scan setting screen 300A shown in FIG. 3A on the display section 119.

In a step S603, the scan application 201 receives a detailed setting instruction provided by the user. The user can instruct the detailed setting by operating e.g. the pointing device 117 and the keyboard 118 to select the control 302 on the scan setting screen 300A.

In a step S604, the scan application 201 requests the general-purpose scan software 202 to display the detailed setting.

In a step S605, the general-purpose scan software 202 requests the extension application 204 to display the detailed setting.

In a step S606, the scan setting screen-extending unit 205 of the extension application 204 displays the detailed setting screen 300C shown in FIG. 3C on the display section 119 in response to the request received in the step S605 (display control step). As described hereinabove, the authentication processing setting is added to the scan function information 203 by the scan function-extending unit 206. The scan setting screen-extending unit 205 can display the detailed setting screen 300C by referring to the capabilities information generated based on the scan function information 203 to which the authentication processing setting has been added. Note that in a case where a setting item of e.g. resolution of an image and the like are included, these setting items can be displayed as required, or can be inhibited from being displayed or be displayed in a grayed-out state.

In a step S607, the scan setting screen-extending unit 205 receives the detailed setting input by the user on the detailed setting screen 300C. Here, it is assumed that, on the detailed setting screen 300C, the control 307 is pressed in a state in which the scanning location of “the original platen glass” is selected by the control 305, by way of example (see FIG. 3C). With this, the detailed setting screen 300D shown in FIG. 3D is displayed on the display section 119. Then, the user designation is input on the control 309 on the detailed setting screen 300D, and the password of the user is input on the control 310. After that, by pressing the control 311 on the detailed setting screen 300D, the input state to the control 309 and the control 310, i.e. the authentication information is stored in the RAM 113, and the detailed setting screen 300D is terminated. Further, the detailed setting screen 300C is displayed again, and the control 306 on the detailed setting screen 300C is pressed. Note that with this pressing operation, the input state to the control 309 and the control 310 can be stored in the RAM 113.

In a step S608, the scan setting screen-extending unit 205 receives termination of the detailed setting performed by the user based on the operation of the control 306 in the step S607. Note that the user can instruct termination of the detailed setting by selecting the control 306 by operating e.g. the pointing device 117 or the keyboard 118. With this, the setting state on the detailed setting screen 300C is written into the scan function information 203. Note that the information written into the scan function information 203 can also include, for example, the information inhibited from being displayed or displayed in the grayed-out state.

In a step S609, the extension application 204 transmits detailed setting termination information to the effect that the detailed setting in the S608 has been terminated, to the general-purpose scan software 202.

In a step S610, the general-purpose scan software 202 receives the detailed setting termination information sent from the extension application 204 in the step S609. Then, the general-purpose scan software 202 transmits this detailed setting termination information to the scan application 201.

In a step S611, the scan application 201 receives a scan instruction provided by the user. The user can provide the scan instruction, i.e. the instruction for reading an original, by selecting the control 303 by operating e.g. the pointing device 117 or the keyboard 118 on the scan setting screen 300A (see FIG. 3A).

In a step S612, the scan application 201 provides the scan instruction received in the step S611 to the general-purpose scan software 202.

In a step S613, the general-purpose scan software 202 receives the scan instruction provided in the step S612. Then, the general-purpose scan software 202 provides this scan instruction to the extension application 204.

In a step S614, the extension application 204 transmits the authentication information stored in the RAM 113 in the step S607 to the scanning device 102 (transmission step). Note that the scanning device 102 has a management function of managing permission/non-permission of use of the scanning device 102 based on the authentication information. Further, the host computer 101 can be configured such that an operation of transmitting the authentication information to the scanning device 102 can be performed. With this, for example, the user can transmit the authentication information at a desired timing.

In a step S615, the CPU 191 of the scanning device 102 receives the authentication information transmitted in the step S614. The CPU 191 determines whether or not to permit use of the scanning device 102, i.e. whether or not to permit execution of scanning (reading function) by the reading section 195 based on this authentication information. Here, it is determined that execution of scanning (reading function) by the reading section 195 is permitted by way of example. Note that in a case where the scan instruction in the step S613 has been provided from the general-purpose scan software 202 to the scanning device 102, it is determined in the step S615 that execution of scanning is not permitted.

In a step S616, if it is determined in the step S615 that execution of scanning is permitted, the CPU 191 transmits a notification notifying this fact to the extension application 204.

In a step S617, the extension application 204 receives the notification to the effect that execution of scanning is permitted, which has been transmitted in the step S616 (reception step). Then, the extension application 204 generates a scan instruction command based on the scan function information 203 in which the setting state to the detailed setting screen 300C has been written in the step S608. Note that this scan instruction command includes the authentication processing setting information received on the detailed setting screen 300C. Further, there is a case where the information inhibited from being displayed or displayed in the grayed-out state in the step S608 has not been written into the scan function information 203. In this case, in the step S617, the extension application 204 can add the information which has not been written into the scan function information 203 to the scan instruction command or can set the information as the default value.

In a step 618, the extension application 204 transmits the scan instruction command generated in the step S617 to the scanning device 102. With this, execution of scanning is instructed to the scanning device 102 (instruction step).

In a step S619, the input/output interface 198 of the scanning device 102 receives the scan instruction command transmitted in the step S618. Then, the reading section 195 of the scanning device 102 interprets the scan instruction command.

In a step S620, the reading section 195 executes scanning under the conditions set on the detailed setting screen 300C based on a result of the interpretation in the step S619. As a result, scanned image data (read image data) of the original is obtained.

In a step S621, the input/output interface 198 of the scanning device 102 transmits the scanned image data obtained in the step S620 to the extension application 204.

In a step 622, the extension application 204 receives the scanned image data transmitted in the step S621. Then, the extension application 204 transmits this scanned image data to the general-purpose scan software 202.

In a step S623, the general-purpose scan software 202 receives the scanned image data sent in the step S622. Then, the general-purpose scan software 202 transmits this scanned image data to the scan application 201.

In a step S624, the scan application 201 receives the scanned image data sent in the step S623. Then, the scan application 201 displays this image data on the display section 119. As a result, the scanned image data of the original is displayed on the display section 119 as a preview image.

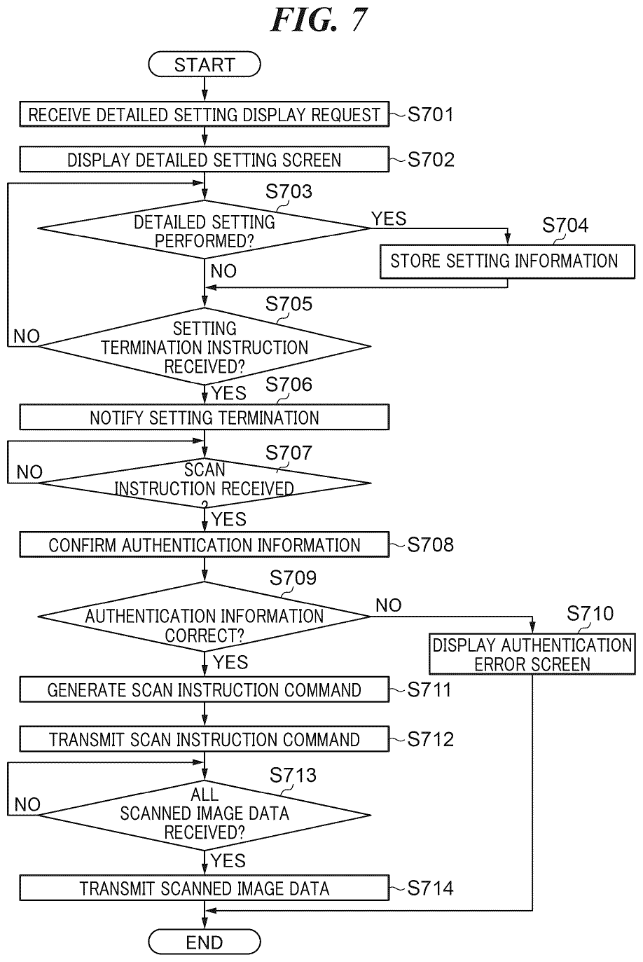

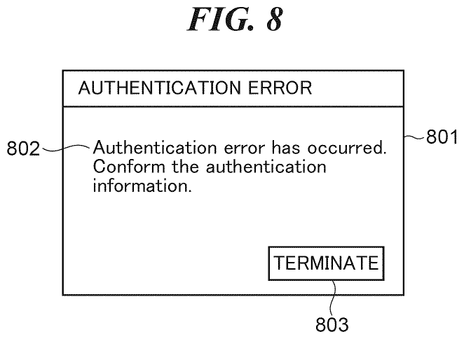

FIG. 7 is a flowchart of the process performed by the extension application 204. A program for executing the process in FIG. 7 is stored in the external storage device 114. The CPU 111 can execute the present process by loading the program from the external storage device 114 into the RAM 113. FIG. 8 is a diagram showing an example of a screen displayed on the display section 119 of the scan system 1000 in a step S710 of the process in FIG. 7. Referring to FIG. 7, in a step S701, the extension application 204 receives the request for displaying the detailed setting (see the step S605) from the general-purpose scan software 202.

In a step S702, the scan setting screen-extending unit 205 of the extension application 204 displays the detailed setting screen 300C shown in FIG. 3C on the display section 119 in response to the detailed setting display request received in the step S701. As described hereinabove, the authentication processing setting is added to the scan function information 203. The scan setting screen-extending unit 205 can display the detailed setting screen 300C by referring to the capabilities information generated based on this scan function information 203.

In a step S703, the scan setting screen-extending unit 205 determines whether or not the detailed setting has been made on the detailed setting screen 300C, i.e. whether or not selection has been performed on the control 305 or an operation has been performed on the control 307. If it is determined in the step S703 that the detailed setting has been made, the process proceeds to a step S704. On the other hand, if it is determined in the step S703 that the detailed setting has not been made, the process proceeds to a step S705.

In the step S704, the scan setting screen-extending unit 205 stores (saves) the setting states (setting information) on the detailed setting screen 300C and the detailed setting screen 300D in the RAM 113. After execution of the step S704, the process proceeds to the step S705.

In the step S705, the scan setting screen-extending unit 205 determines whether or not a detailed setting termination instruction has been provided on the detailed setting screen 300C, i.e. whether or not control 306 has been operated. If it is determined in the step S705 that a detailed setting termination instruction has been provided, the process proceeds to a step S706. On the other hand, if it is determined in the step S705 that a detailed setting termination instruction has not been provided, the process returns to the step S703 to sequentially execute the step S703 et seq.

In the step S706, the extension application 204 notifies the general-purpose scan software 202 of the detailed setting termination instruction provided in the step S705.

In a step S707, the extension application 204 determines whether or not a scan instruction has been provided from the general-purpose scan software 202 (see the step S613). If it is determined in the step S707 that a scan instruction has been provided, the process proceeds to a step S708. On the other hand, if it is determined in the step S707 that a scan instruction has not been provided, the process remains in the step S707.

In the step S708, the extension application 204 causes the scanning device 102 (the CPU 191) to determine, based on the authentication information, whether or not to permit execution of the scan function (see the step S615). Note that the scanning device 102 notifies the extension application 204 of a result of this determination (see the step S616).

In a step S709, the extension application 204 receives the result of the determination from the scanning device 102 (reception step). Then, the extension application 204 determines, based on this determination result, whether or not the authentication information is correct, i.e. execution of the scan function is permitted. If it is determined in the step S709 that the authentication information is correct, the process proceeds to a step S711. On the other hand, if it is determined in the step S709 that the authentication information is incorrect, the process proceeds to the step S710.

In the step S710, the extension application 204 controls the notification unit 209 to notify the user that execution of the scan function in the scanning device 102 is not permitted, i.e. the scan function cannot be executed (authentication error) (notification step). An authentication error screen 801 shown in FIG. 8 is a screen notifying the user of the authentication error in the step S710 and is displayed on the display section 119. The authentication error screen 801 includes a message 802 and a control 803, and the message 802 includes a massage to the effect that “Authentication error has occurred. Conform the authentication information”. Thus, the message 802 is a message for prompting the user to reconfirm the authentication information. By operating the control 803, the authentication error screen 801 is closed. After that, on the display section 119, the detailed setting screen 300C and the detailed setting screen 300D are sequentially displayed, or the detailed setting screen 300D is displayed. With this, the user can reinput the authentication information on the detailed setting screen 300D. After execution of the step S710, the process is terminated.

In the step S711, the extension application 204 generates a scan instruction command based on the scan function information 203 in which the setting state on the detailed setting screen 300C has been written (see the step S617). Further, as the method of generating a scan instruction command, for example, a method of extending a standard protocol command can be used. Further, as this extension method, for example, a method of describing a dedicated command in an extended area of the standard protocol command can be used. The other extension methods include a method of adding an original standard command to the end of the standard protocol command, a method of the extension application 204 overwriting the standard protocol command with an original command system, and so forth. Further, in a case where an instruction is provided from the extension application 204, instruction and communication can be performed according to a protocol unique to a maker regardless of the standard protocol.

In a step S712, the extension application 204 transmits the scan instruction command generated in the step S711 to the scanning device 102 (see the step S618).

In a step S713, the extension application 204 determines whether or not all of the scanned image data (see the step S622) from the scanning device 102 have been received. If it is determined in the step S713 that all pieces of the scanned image data have been received, the process proceeds to a step S714. On the other hand, if it is determined in the step S713 that all pieces of the scanned image data have not been received, the process remains in the step S713.

In the step S714, the extension application 204 transmits all pieces of the scanned image data, which have been received from the scanning device 102 and determined in the step S713, to the general-purpose scan software 202 (see the step S622). After execution of the step S714, the process is terminated.

As described above, in the scan system 1000, even in a case where the general-purpose scan software 202 does not support the authentication processing setting, it is possible to execute the authentication processing setting by using the extension application 204. This enables the scanning device 102 to perform, when causing the scanning device 102 to execute the scan function, determination whether or not to permit execution of the scan function, i.e. perform authentication for permission of execution of the scan function. Then, in a case where execution of the scan function is permitted, it is possible to execute the scan function by using the scanning device 102. On the other hand, in a case where execution of the scan function is not permitted, it is possible to reinput the authentication information. Then, if this authentication information is correct, it is possible to execute the scan function by using the scanning device 102.

Further, in the step S613, the scan instruction is provided from the general-purpose scan software 202 to the extension application 204, but this is not limitative. For example, the scan instruction can be provided from the scan application 201 to the extension application 204. Further, a control for a scan instruction can be disposed on the detailed setting screen 300C. In this case, by the user operating the control for a scan instruction, a scan instruction is provided to the extension application 204. Further, the scanned image data can be transmitted from the scanning device 102 to the scan application 201 via the extension application 204 without via the general-purpose scan software 202. Further, the scanned image data can be transmitted from the scanning device 102 directly to the scan application 201. Further, the scan system 1000 can be configured such that the scanned image data is stored in the external storage device 114, and only information on a file path as the storage destination can be sent and received. Further, in the scan system 1000, in a case where there are a plurality of pieces of scanned image data, all the pieces of the scanned image data can be collectively transmitted, or each piece of scanned image data can be transmitted whenever the scanned image data is obtained.

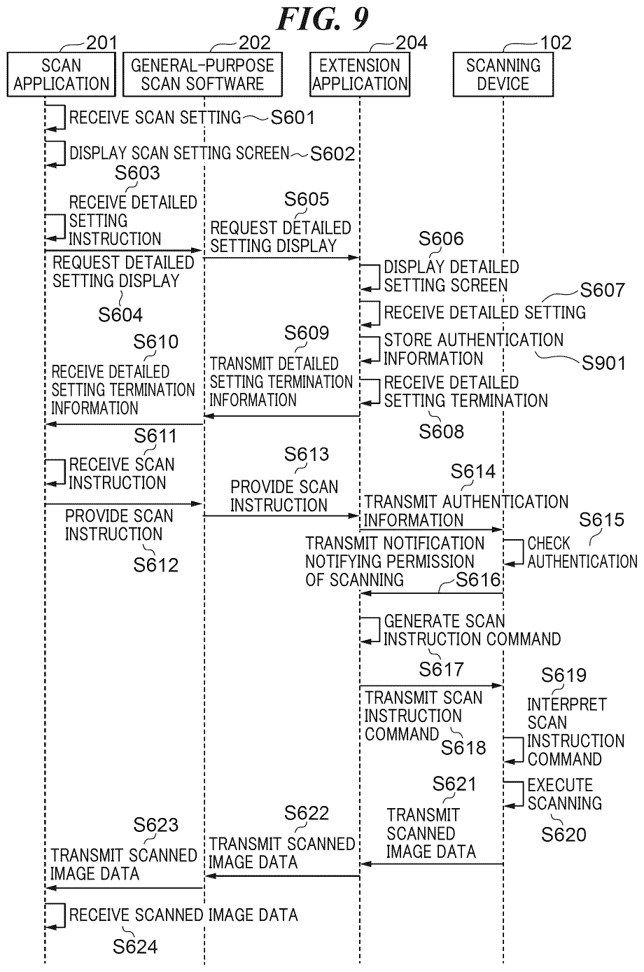

Next, a second embodiment will be described below with reference to FIG. 9, but the description will be given mainly of different points from the above-described embodiment, and description of the same points is omitted. When the scanning device 102 is used, depending on its use environment, there is a case where confirmation of the authentication information is not required to be performed for each scanning operation. The use environment of the scanning device 102 in this case includes, for example, an environment in which a small number of (e.g. two) users permitted to perform scanning by the scanning device 102 use the host computer 101. In the present embodiment, the scan system 1000 in this environment will be described.

FIG. 9 is a sequence diagram showing a process executed between the scan application 201, the general-purpose scan software 202, the extension application 204, and the scanning device 102, after the scan application 201 receives a scan setting in the second embodiment. In the sequence diagram shown in FIG. 9, differently from the sequence diagram shown in FIG. 6, a step S901 is added between the steps S607 and S608. As shown in FIG. 9, in the step S901, the extension application 204 stores the authentication information included in the detailed setting received in the step S607, on the side of the extension application 204 (storage step). Then, after this storage step, scanning thereafter can be executed even when the redisplay of the detailed setting screen 300D is not displayed again, i.e. even when the redisplay of the detailed setting screen 300D is omitted. Further, in the step S614, the extension application 204 can transmit the authentication information stored in the step S901 to the scanning device 102.

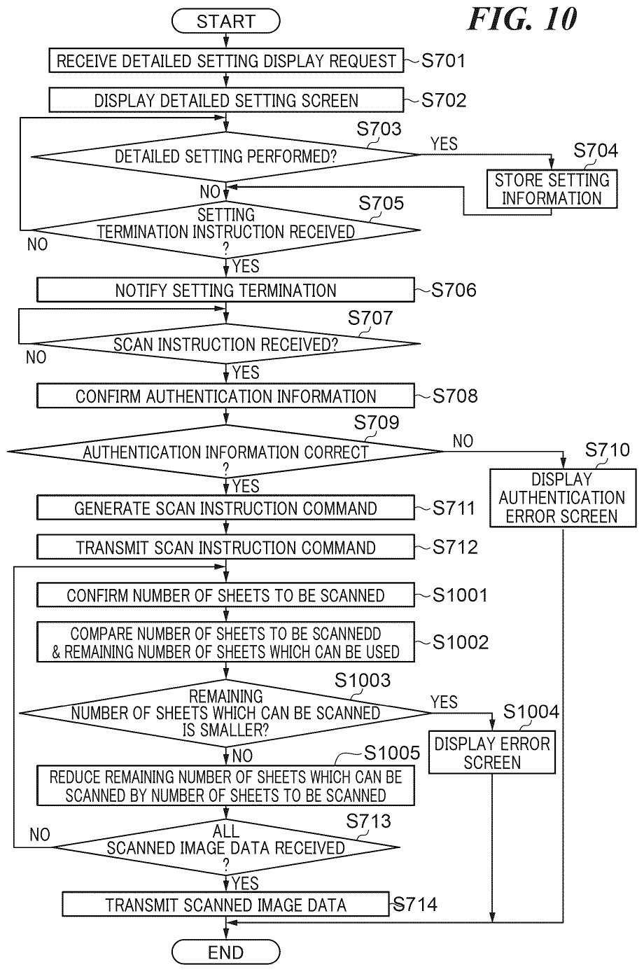

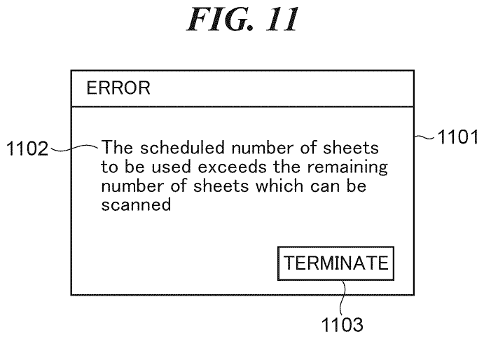

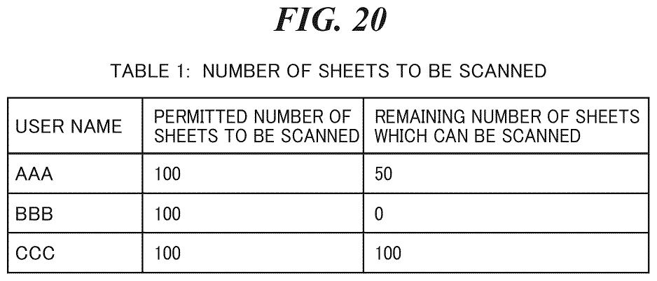

A third embodiment will be described below with reference to FIGS. 10 and 11, but the description will be given mainly of different points from the above-described embodiments, and description of the same points is omitted. When the scanning device 102 is used, depending on its use environment, there is a case where the number of sheets which can be scanned is desired to be limited on an authentication information basis. The use environment of the scanning device 102 in this case includes, for example, an environment in which the scanning device 102 is used with a setting of the maximum number of sheets that can be scanned for each user, set to maximum 100 sheets per one month. In the present embodiment, the scan system 1000 in this environment will be described. The authentication information includes sheet number information concerning the remaining number of original sheets which can be scanned for each user requesting permission of execution of scanning (see a table 1 shown in FIG. 20).

As shown in the table 1, for example, in a case where a user having a user name “AAA” is the user, the permitted number of sheets to be scanned is “100 sheets” per one month, and the remaining number of original sheets which can be scanned at present in this month is “50 sheets”. Therefore, the table 1 shows a state in which the user having the user name “AAA” has already caused the scanning device 102 to execute scanning 50 sheets. Although, in the present embodiment, the data in this table 1 is stored in the ROM 192 or the external storage device 199 of the scanning device 102, this is not limitative, but, for example, the data can be stored in a medium which can be referred to from the scanning device 102. Further, in the table 1, for example, the permitted number of sheets to be scanned can be divided into the number of sheets for color printing and the number of sheets for monochrome printing, or the permitted number of sheets to be scanned can be omitted, or information on a department to which the user belongs can be included.

FIG. 10 is a flowchart of a process performed by the extension application 204 according to the third embodiment. FIG. 11 is a diagram showing an example of a screen displayed on the display section 119 of the scan system 1000 in a step S1004 of the process in FIG. 10. In the process in FIG. 10, differently from the process in FIG. 7, steps S1001 to S1005 are added between the steps S712 and S713. As shown in FIG. 10, in the step S1001, the extension application 204 acquires information concerning the number (scheduled number) of sheets to be used for execution of scanning by the scanning device 102. This information can be information acquired from the scanning device 102, or information concerning the scheduled number of sheets to be used (scheduled number of sheets to be read), which has been counted by the CPU 111, can be used.

In the step S1002, the extension application 204 compares the scheduled number of sheets to be used, which is included in the information acquired in the step S1001, and the remaining number of sheets which can be used for execution of scanning (comparison step).

In the step S1003, the extension application 204 determines, based on a result of the comparison in the step S1002, whether or not the remaining number of sheets which can be used is smaller than the scheduled number of sheets to be used. If it is determined in the step S1003 that the remaining number of sheets which can be used is smaller, the process proceeds to the step S1004. On the other hand, if it is determined in the step S1003 that the remaining number of sheets which can be used is not smaller, i.e. the scheduled number of sheets to be used is smaller, the process proceeds to the step S1005.

In the step S1004, the extension application 204 controls the notification unit 209 to display an error screen 1101 shown in FIG. 11 on the display section 119 (notification step). The error screen 1101 includes a message 1102 and a control 1103. The message 1102 includes a message to the effect that “The scheduled number of sheets to be used exceeds the remaining number of sheets which can be scanned”. By operating the control 1103, the error screen 1101 is closed. After that, it is preferable, for example, to perform scanning again, to thereby make the remaining number of sheets which can be scanned larger than the scheduled number of sheets to be used.

In the step S1005, the extension application 204 stores the number of sheets obtained by subtracting the scheduled number of sheets to be used from the remaining number of sheets which can be scanned, as a new remaining number of sheets which can be scanned (storage step). After execution of the step S1005, the process proceeds to the step S713. In the present embodiment, if it is determined in the step S713 that all pieces of the scanned image data have not been received, the process returns to the step S1101.

Thus, in the present embodiment, it is possible to cause the scanning device 102 to execute scanning within a range of the maximum number of sheets which can be scanned for each user.

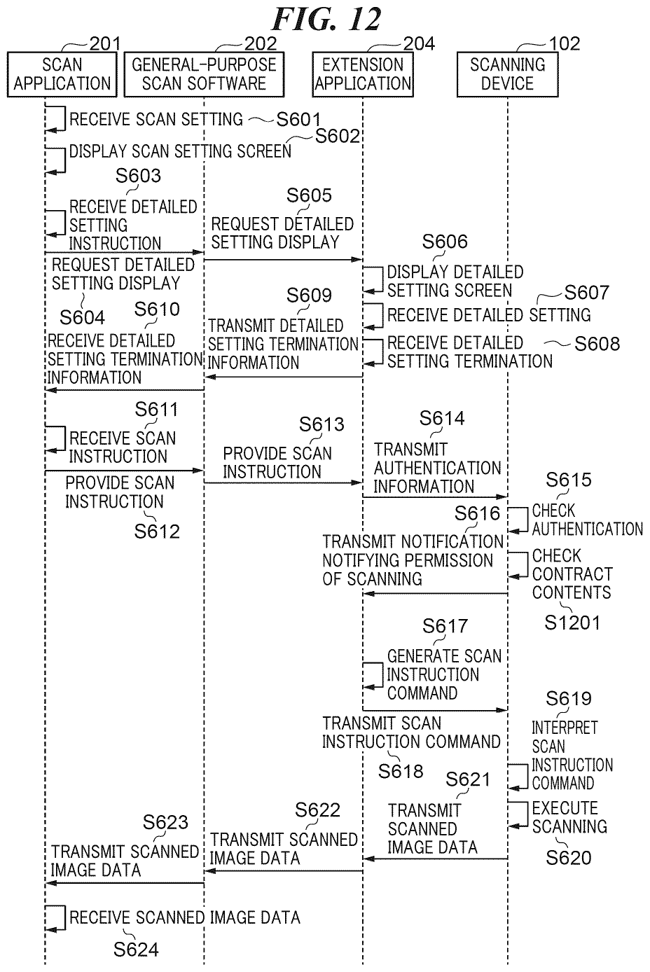

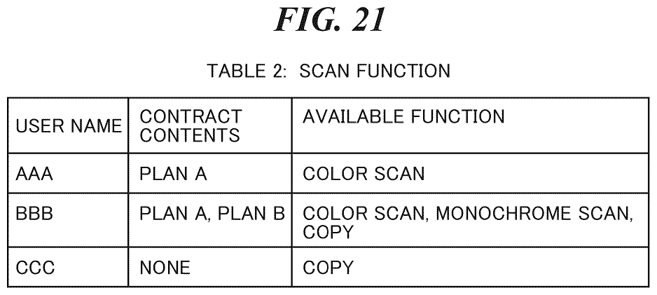

A fourth embodiment will be described below with reference to FIGS. 12 to 14, but the description will be given mainly of different points from the above-described embodiments, and description of the same points is omitted. When the scanning device 102 is used, depending on its use environment, there is a case where the operation of the scanning device 102 is desired to be limited based on determination including other limitation information for each authentication information. The use environment of the scanning device 102 in this case includes, for example, an environment in which the contents of the contract are different for each user, and there is a function which can be used by the scanning device 102 only for a user who has made a specific contract. In the present embodiment, the scan system 1000 in this environment will be described. For example, the authentication information includes the contract contents and the functions of the scanning device 102, which can be used based on the contract contents (see a table 2 shown in FIG. 21).

As shown in the table 2, for example, in a case where the user is a user having the user name “AAA”, the contract contents are “plan A”, and the function of the scanning device 102, which can be used based on the plan A, is “color scanning”. Thus, scanning includes a plurality of types of scanning (such as color scanning and monochrome scanning). Then, the plurality of types of scanning are different for each of the contract contents of the user requesting permission of execution of scanning. Note that although, in the present embodiment, the data in the table 2 is stored in the ROM 192 or the external storage device1 199 of the scanning device 102, this is not limitative, but for example, the data can be stored in a medium which can be referred to from the scanning device 102. Further, in the table 2, the functions of the scanning device 102, which can be used, can be omitted, and information on a department to which the user belongs can be included.

FIG. 12 is a sequence diagram showing a process executed, in the fourth embodiment, between the scan application 201, the general-purpose scan software 202, the extension application 204, and the scanning device 102, after the scan application 201 receives a scan setting. In the sequence diagram shown in FIG. 12, differently from the sequence diagram shown in FIG. 6, a step S1201 is added between the steps S615 and S616. As shown in FIG. 12, in the step S1201, the CPU 191 of the scanning device 102 acquires, from the authentication information received in the step S615, the contract contents included in this authentication information, i.e. checks the contract contents.

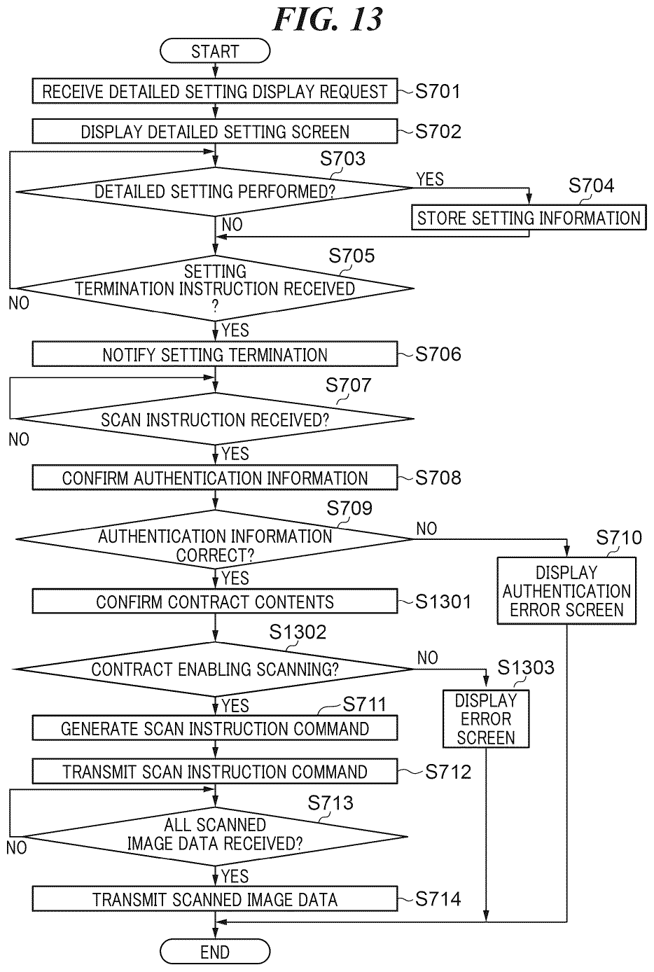

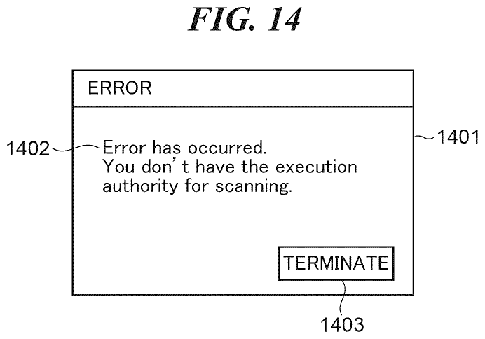

FIG. 13 is a flowchart of a process performed by the extension application 204. FIG. 14 is a diagram showing an example of a screen displayed on the display section of the scan system in a step S1303 of the process in FIG. 13. In the process in FIG. 13, differently from the process in FIG. 7, steps S1301 to S1303 are added between the steps S709 and S711. As shown in FIG. 13, in the step S1301, the extension application 204 acquires the contract contents included in the authentication information and information concerning the functions of the scanning device 102, which can be used based on the contract contents (see the step S1201).

In the step S1302, the extension application 204 determines whether or not the contract of the user associated with the authentication information is a contract which enables scanning, i.e. with which scanning according to the contract contents can be executed (determination step). If it is determined in the step S1302 that the contract is a contract which enables scanning, the process proceeds to the step S711. With this, in the step S712, it is possible to instruct the scanning device 102 to execute scanning according to the contract contents (instruction step). On the other hand, if it is determined in the step S1302 that the contract is not a contract which enables scanning, the process proceeds to the step S1303.

In the step S1303, the extension application 204 controls the notification unit 209 to display an error screen 1401 shown in FIG. 14 on the display section 119 (notification step). The error screen 1401 includes a message 1402 and a control 1403. The message 1402 includes a message to the effect that “You don't have the execution authority for scanning according to the contract contents”. By operating the control 1403, the error screen 1401 is closed. After that, for example, it is preferable to change execution of scanning according to the contract contents. After execution of the step S1303, the process is terminated.

As described above, in the present embodiment, it is possible to execute scanning within the range of the contract for each user.

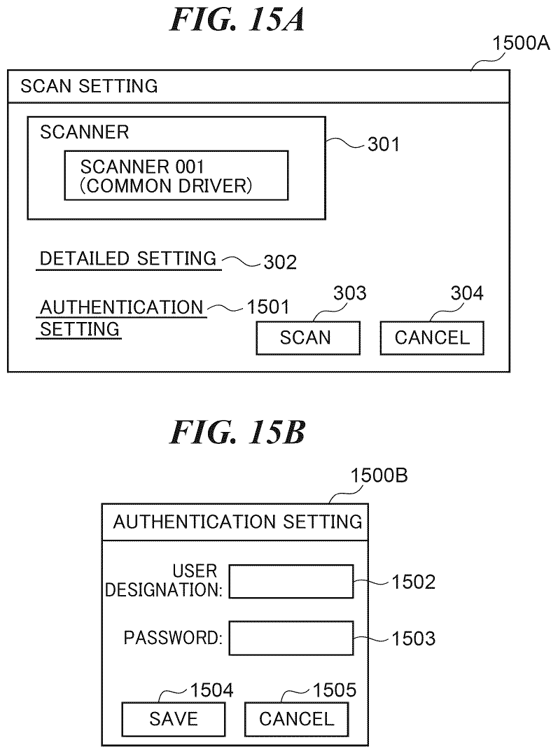

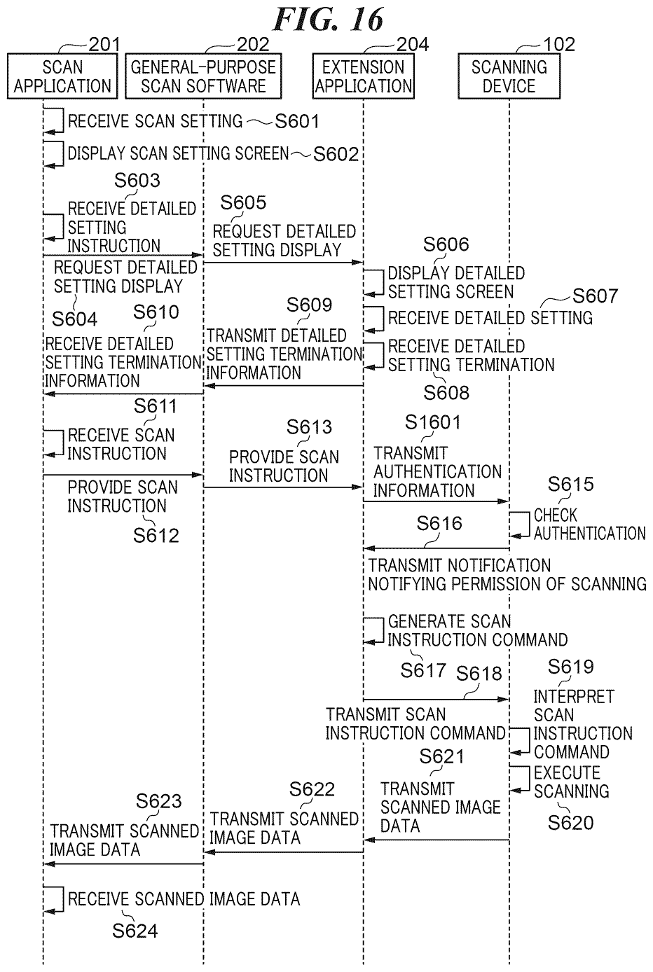

A fifth embodiment will be described below with reference to FIGS. 15A and 15B, and 16, but the description will be given mainly of different points from the above-described embodiments, and description of the same points is omitted. FIGS. 15A and 15B are diagrams each showing an example of a screen displayed on the display section 119 of the scan system 1000 according to the fifth embodiment. FIG. 15A shows a scan setting screen displayed by the extension application 204. FIG. 15B shows a detailed setting screen transitioned from the extension application 204. A scan setting screen 1500A shown in FIG. 15A is a screen on which settings related to scanning performed by the scanning device 102 can be made. This scan setting screen 1500A includes the controls 301 to 304 and further includes a control 1501. By operating the control 1501, a detailed setting screen 1500B shown in FIG. 15B is displayed on the display section 119. The detailed setting screen 1500B includes controls 1502 to 1505. The control 1502 is, similar to the control 309 on the detailed setting screen 300D, a user designation input section for inputting a designation of a user as the authentication information. The control 1503 is, similar to the control 310, a password input section for inputting a password of a user having the designation input on the control 1502. With the control 1504, the user can store the input state to the control 1502 and the control 1503 in the extension application 204 and terminate the detailed setting screen 1500B. With the control 1505, the user can cancel the input state to the control 1502 and the control 1503 and terminate the detailed setting screen 1500B. Then, after termination of the detailed setting screen 1500B, the screen is returned to the scan setting screen 1500A.

FIG. 16 is a sequence diagram showing a process executed between the scan application 201, the general-purpose scan software 202, the extension application 204, and the scanning device 102, after the scan application 201 receives a scan setting. In the sequence diagram shown in FIG. 16, a step S1601 is added in place of the step S614 of the sequence diagram shown in FIG. 6. As shown in FIG. 16, in the step S1601, the extension application 204 transmits the authentication information input on the detailed setting screen 1500B and stored in the extension application 204 to the scanning device 102.

In the above-described embodiment, it is possible to omit inputting of the authentication information for each execution of scanning.

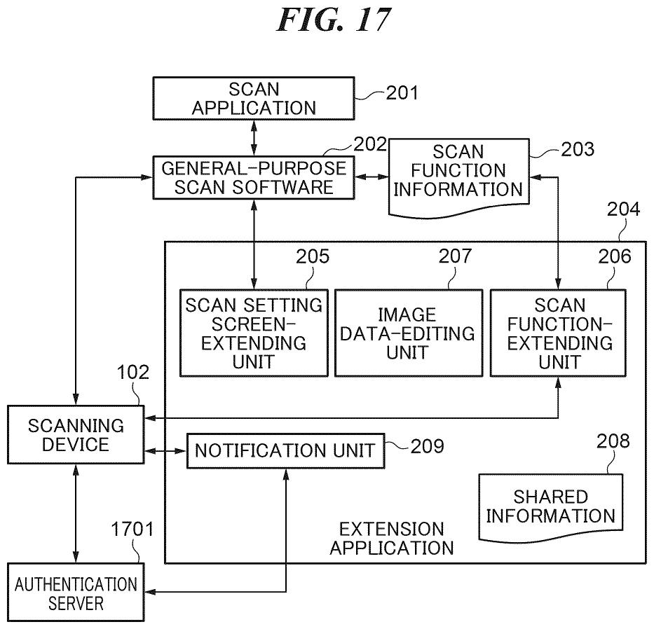

A sixth embodiment will be described below with reference to FIGS. 17 to 19, but the description will be given mainly of different points from the above-described embodiments, and description of the same points is omitted. FIG. 17 is a block diagram showing a software configuration of the scan system according to the sixth embodiment. As shown in FIG. 17, the extension application 204 (notification unit 209) and the scanning device 102 are communicably connected to an authentication server 1701, respectively. The authentication server 1701 is a management server that stores the authentication information and further executes determination of whether or not the authentication information is correct, i.e. manages permission/non-permission of use of the scanning device 102.

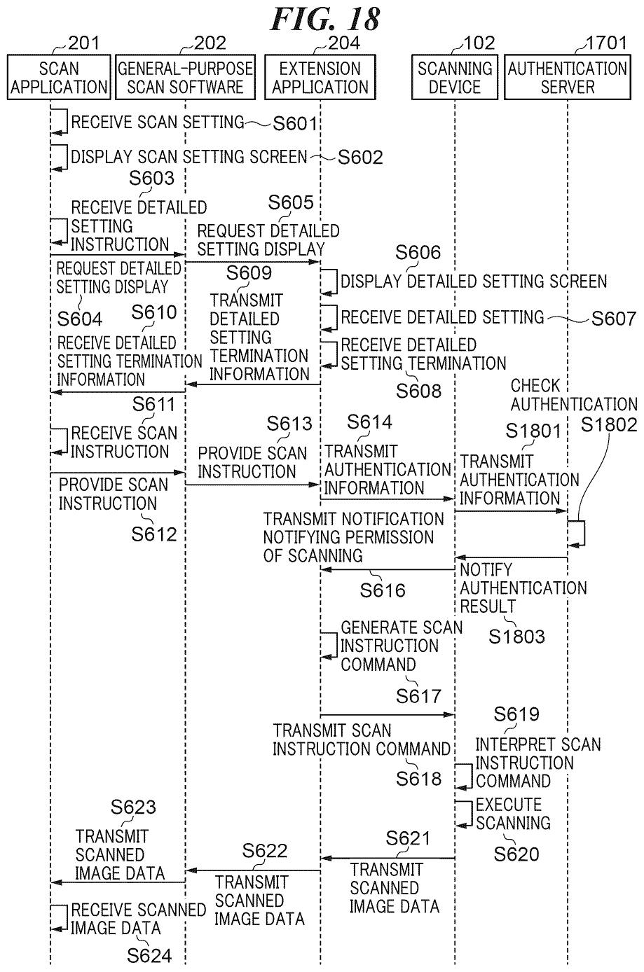

FIG. 18 is a sequence diagram showing a process executed between the scan application 201, the general-purpose scan software 202, the extension application 204, the scanning device 102, and the authentication server 1701, after the scan application 201 receives a scan setting. In the sequence diagram shown in FIG. 18, differently from the sequence diagram shown in FIG. 6, steps S1801 to S1803 are added in place of the step S615. As shown in FIG. 18, in the step S1801, the scanning device 102 receives the authentication information transmitted in the step S614. Then, the scanning device 102 transmits this authentication information to the authentication server 1701 (transmission step).

In the step S1802, the authentication server 1701 receives the authentication information transmitted in the step S1801. The authentication server 1701 determines, based on this authentication information, whether or not to permit use of the scanning device 102. Here, it is determined that use of the scanning device 102 is permitted, i.e. execution of scanning is permitted by way of example.

In the step S1803, the authentication server 1701 transmits a notification to the effect that execution of scanning is permitted as a result of the determination in the step S1802 to the scanning device 102.

In the step S616 after execution of the step S1803, the scanning device 102 receives the notification transmitted in the step S1803 and transmits the notification to the extension application 204.

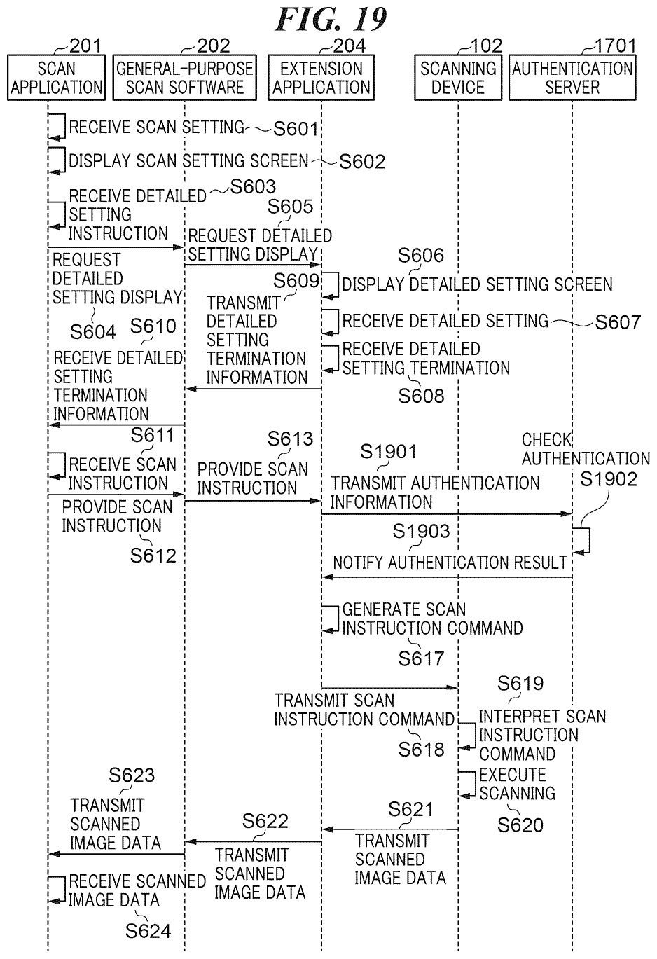

FIG. 19 is a sequence diagram showing a variation of the process executed between the scan application 201, the general-purpose scan software 202, the extension application 204, the scanning device 102, and the authentication server 1701, after the scan application 201 receives a scan setting. In the sequence diagram shown in FIG. 19, differently from the sequence diagram shown in FIG. 18, steps S1901 to S1903 are added in place of the step S614, the steps S1801 to S1803, and the step S616. As shown in FIG. 19, in the step S1901, the extension application 204 transmits the authentication information to the authentication server 1701 (transmission step).

In the step S1902, the authentication server 1701 receives the authentication information transmitted in the step S1901. The authentication server 1701 determines, based on this authentication information, whether or not to permit use of the scanning device 102. Here, it is determined that use of the scanning device 102 is permitted, i.e. execution of scanning is permitted by way of example.

In the step S1903, the authentication server 1701 transmits a notification to the effect that execution of scanning is permitted as a result of the determination in the step S1902 to the extension application 204.

In the step S617 after execution of the step S1903, the extension application 204 receives the notification transmitted in the step S1903. Then, the extension application 204 generates a scan instruction command based on the scan function information 203.

As described above, in the present embodiment, the authentication server 1701 can determine whether or not to permit use of the scanning device 102 in place of the scanning device 102.

According to the present disclosure, when causing the scanning device 102 to execute the scan function, it is possible to perform authentication for permission of execution of the scan function.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-230235, filed Dec. 26, 2024, which is hereby incorporated by reference herein in its entirety.

What is claimed is:

1. A non-transitory computer-readable storage medium storing an application program causing a computer to execute the following method comprising:
supporting a standard driver which is provided from a provider of an operating system:
displaying a reception screen for receiving authentication information required to cause an image processing apparatus having a reading function of reading an original to execute the reading function; and
receiving the authentication information on the reception screen.

2. The non-transitory computer-readable storage medium according to claim 1, wherein the reception screen includes a user designation input section for inputting a designation of a user requesting permission of use of the reading function, as the authentication information, and a password input section for inputting a password of the user, as the authentication information.

3. The non-transitory computer-readable storage medium according to claim 1, wherein the method further included instructing the image processing apparatus to execute the reading function, in a case where execution of the reading function is permitted based on the authentication information transmitted to the image processing apparatus.

4. The non-transitory computer-readable storage medium according to claim 3, wherein the method further comprises:
receiving, in a case where execution of the reading function is permitted, a notification notifying this fact, and
instructing, in a case where the notification is received, the image processing apparatus to execute the reading function.

5. The non-transitory computer-readable storage medium according to claim 3, wherein the authentication information includes sheet number information concerning a remaining number of original sheets on which the reading function can be executed, on a user-by-user basis for users requesting permission of execution of the reading function, and
wherein the method further comprises:
comparing the number of read sheets used in execution of the reading function and the remaining number of original sheets,
notifying, in a case where the remaining number of original sheets is smaller than the number of read sheets, this fact, and
storing, in a case where the remaining number of original sheets is not smaller than the number of read sheets, the number of sheets obtained by subtracting the number of read sheets from the remaining number of original sheets, as a new remaining number of original sheets.

6. The non-transitory computer-readable storage medium according to claim 3, wherein the reading function includes a plurality of types of reading functions, and the plurality of types of reading functions are different on a user-by-user basis for users of contents of the contract of a user requesting permission of execution of the reading function, and
wherein the authentication information includes the contract contents, and
wherein the method further comprises:
determining whether or not the reading function is to be executed according to the contract contents, after instructing execution of the reading function,
notifying, in a case where it is determined that the reading function is not to be executed according to the contract contents, this fact, and
instructing, in a case where it is determined that the reading function is to be executed according to the contract contents, the image processing apparatus to execute the reading function.

7. The non-transitory computer-readable storage medium according to claim 3, wherein the method further comprises performing, in a case where execution of the reading function is not permitted based on the authentication information transmitted to the image processing apparatus, a predetermined notification notifying this fact.

8. The non-transitory computer-readable storage medium according to claim 7, wherein the method further comprises receiving, in a case where execution of the reading function is not permitted, a notification notifying this fact, and
wherein the predetermined notification notifying the fact is performed in a case wherein the notification is received.

9. The non-transitory computer-readable storage medium according to claim 1, wherein the image processing apparatus has a management function of managing permission/non-permission of use of the image processing apparatus, and
wherein the authentication information is transmitted to the image processing apparatus.

10. The non-transitory computer-readable storage medium according to claim 1, wherein the image processing apparatus is managed by a management server with respect to permission/non-permission of use of the image processing apparatus, and
wherein the authentication information is transmitted to the management server.

11. A control method comprising:
supporting a standard driver which is provided from a provider of an operating system by executing an application program;
displaying a reception screen for receiving authentication information required to cause an image processing apparatus having a reading function of reading an original to execute the reading function by executing the application program; and
receiving the authentication information on the reception screen.

12. An information processing apparatus comprising:
an application program that supports the standard driver provided from a provider of an operating system,
a display unit for displaying a reception screen for receiving authentication information required to cause an image processing apparatus having a reading function of reading an original to execute the reading function by executing the application program; and
a reception unit for receiving the authentication information on the reception screen.
